(19) United States
(12) Patent Application Publication
(10) Pub. No.: US 2013/0180356 A1
(43) Pub. Date: Jul. 18, 2013

(54) Assistance device for operating a pedal of a motor vehicle and pedal comprising the assistance device

(71) Applicant: BATZ, S.COOP., Igorre (ES)

(72) Inventors: Fernando BURGUERA ALBIZURI, BILBAO (ES); Lander LLONA FURUNDARENA, LEZAMA (ES); Eider BILBAO SANTAMARIA, SOPELANA (ES)

(73) Assignee: BATZ, S.COOP., IGORRE (ES)

(21) Appl. No.: 13/744,323

(22) Filed: Jan. 17, 2013

(30) Foreign Application Priority Data
Jan. 18, 2012 (ES) P201230068

(51) Int. Cl. G05G 1/44

(52) U.S. Cl. CPC G05G 1/44
USPC 74/560

(57) ABSTRACT

A pedal assembly having an assistance device. In some implementations the assistance device comprises a profile fixed to the arm of a pedal, the arm of the pedal being pivotally coupled to a support. The profile includes an elongate curved surface that is acted upon by a spring-actuated lever attached to the support. In operation as the pedal arm is moved between a rest position and one or more active positions, the lever applies a force to the arm through the profile by acting upon on one or more portions of the elongate curved surface, the direction of the force applied to the arm being dependent upon the portion of the elongate curved surface being acted upon by the lever.

### CROSS-REFERENCE TO RELATED APPLICATIONS

This application relates to and claims the benefit and priority to Spanish Patent Application No. P201230068, filed Jan. 18, 2012.

### FIELD

The present invention relates to an assistance device for operating a pedal of a motor vehicle and to a pedal comprising the assistance device.

### BACKGROUND

Pedals comprising assistance devices which aid in improving the effort which a driver must exert on the shoe of a pedal for operating a servobrake or a clutch are known in the automotive industry.

U.S. Publication No. 2005/0252334A1 describes a clutch pedal assembly comprising a spring and a cam fixed to a support on which the pedal acts, such that the cam, having a specific profile, compresses the spring during the stroke of the pedal.

European Publication No. EP480602A1 describes a pedal having an arm, the end of which presses a leaf spring element as it moves between the resting position and the clutch or active position.

Spanish Patent No. ES20205415T3 describes an assistance device comprising a profile integral with the pedal and delimited by an angular sector cooperating with a rolling means suitable for moving according to a substantially horizontal direction through the action of an elastic means.

### SUMMARY OF THE DISCLOSURE

According to some implementations an assistance device is provided that comprises a profile coupled to an arm of the pedal, elastic means coupled to a support of the pedal and rolling means acting on the profile operated by the elastic means, exerting additional force on the arm of the pedal, between a resting position of the pedal and an active position of the pedal. The assistance device further comprises a lever which is arranged pivotally coupled to the support and at one of the ends of which the rolling means and the elastic means are coupled.

The elastic means exert stress on the lever, the stress being transmitted through the rolling means against the profile. The arrangement of the elastic means with respect to the rolling means reduces, or otherwise minimizes contact forces among the various components to reduce friction that can result in high hysteresis which can be seen in the force necessary for moving the pedal.

The configuration of the assistance device also reduces the number of necessary elements.

These and other advantages and features will be more evident in view of the figures and the detailed description.

### BRIEF DESCRIPTION OF THE DRAWINGS

FIG. 1 shows a perspective view of a pedal assembly of a motor vehicle with an assistance device according one implementation.

FIG. 2 shows another perspective view of the pedal assembly shown in Figure

FIG. 3 shows an exploded view of the pedal assembly shown in FIG. 1.

FIG. 4 shows a side view of the pedal assembly shown in FIG. 1 in an initial or resting position.

FIG. 5 shows a side view of the pedal assembly shown in FIG. 1 in a position with zero assistance force.

FIG. 6 shows a side view of the pedal assembly shown in FIG. 1 in a position with maximum assistance force.

FIG. 7 shows a side view of the pedal assembly shown in FIG. 1 in a position with residual assistance force.

FIG. 8 shows a diagram of the force generated on a shoe of the pedal assembly shown in FIG. 1 according to one implementation.

FIG. 9 shows a perspective view of a profile according to one implementation.

FIG. 10 shows a section of the profile shown in FIG. 9 according to plane IX.

FIG. 11 shows a perspective view of a profile according to another implementation.

FIG. 12 shows a section of the profile shown in FIG. 11 according to plane XII

FIG. 13 shows a diagram of the force generated on a shoe of the pedal assembly shown in FIG. 1 with the profile shown in FIG. 11.

FIG. 14 shows a perspective view of a profile according to another implementation.

FIG. 15 shows a section of the profile shown in FIG. 14 according to plane XIV.

FIG. 16 shows a diagram of the force generated on a shoe of the pedal shown in FIG. 1 with the profile shown in FIG. 14.

FIG. 17 shows a perspective view of a profile according to another implementation.

FIG. 18 shows a section of the profile shown in FIG. 17 according to plane XVII.

FIG. 19 shows a diagram of the force generated on a shoe of the pedal shown in FIG. 1 with the profile shown in FIG. 17.

### DETAILED DESCRIPTION

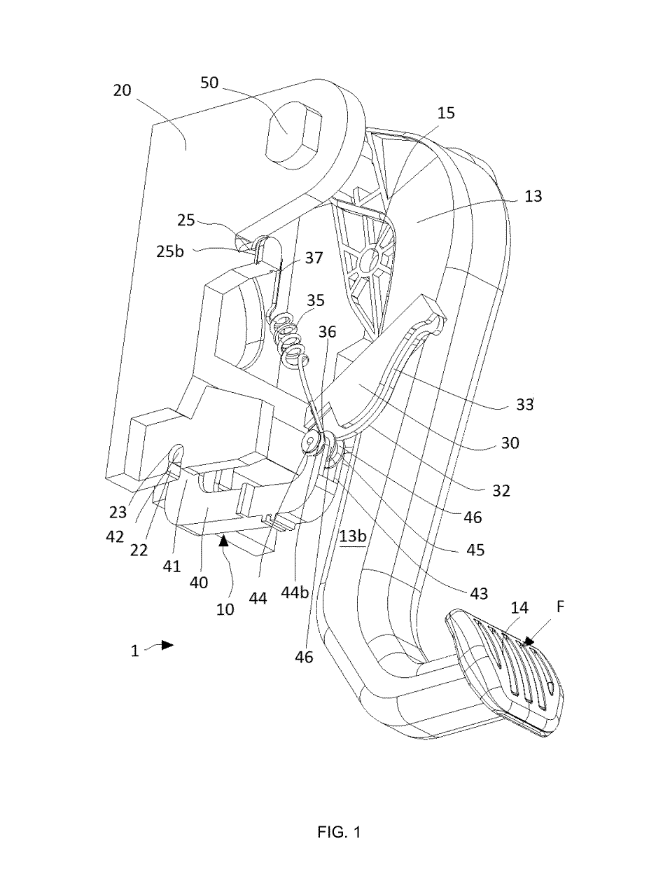

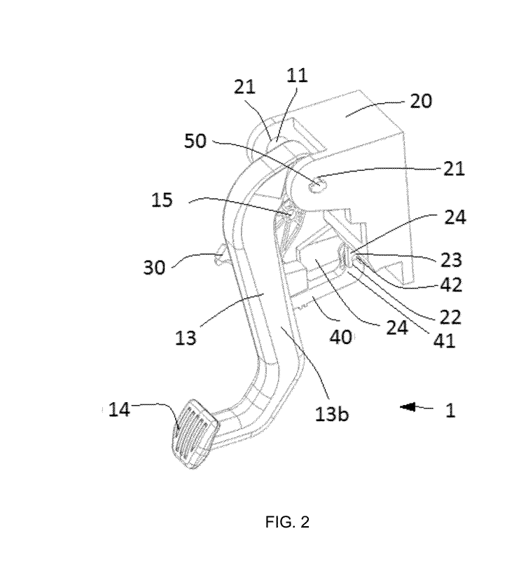

FIGS. 1 to 7 show a clutch or brake pedal 1 adapted to a motor vehicle which comprises a support 20, an arm 13 pivotal with respect to the support 20, and a shoe 14 arranged at one end of the arm 13, operable by a user. The pedal 1 further comprises a non-depicted actuating rod which is arranged coupled to the arm 13 through a coupling 15 and which transmits an activation force F,F′,F″ exerted on the shoe 14 by the driver, to a non-depicted actuator, primarily a servobrake or a clutch.

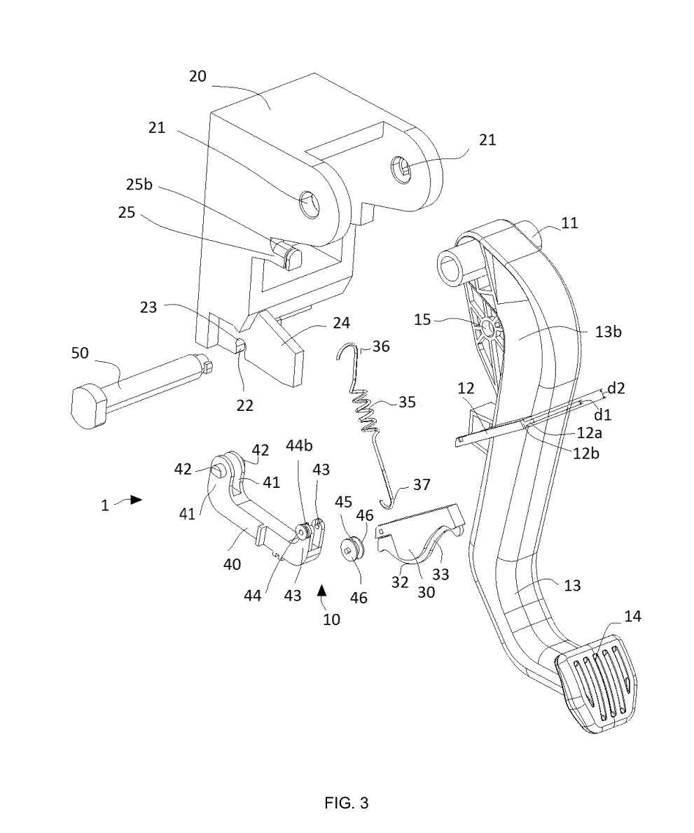

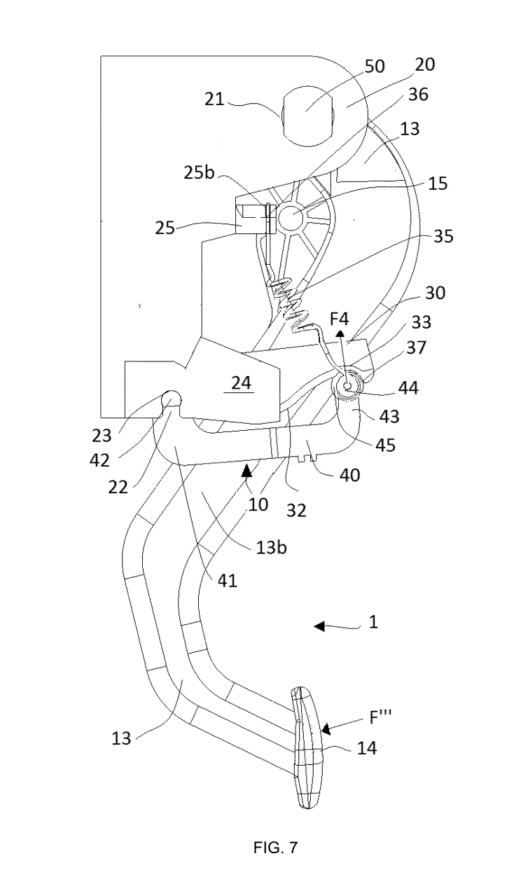

According to one implementation the pedal 1 comprises a shaft 50 through which the arm 13 is coupled to the support 20, the shaft 50 traversing the support 20 through holes 21, shown in FIG. 3, and an end 11 of the arm 13, the arm 13 being pivotal between an initial or resting position shown in FIG. 4 and a final active position or a position with the operated pedal shown in FIG. 7.

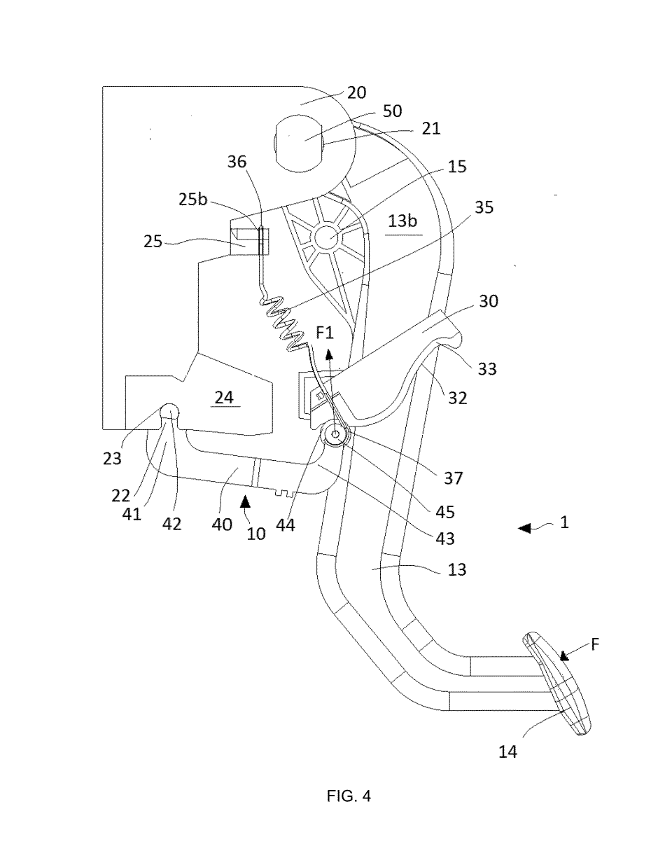

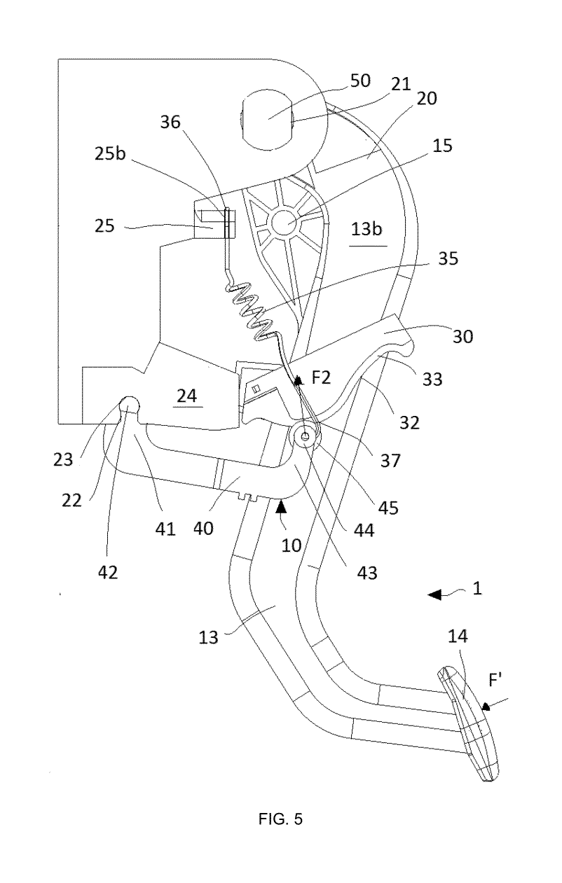

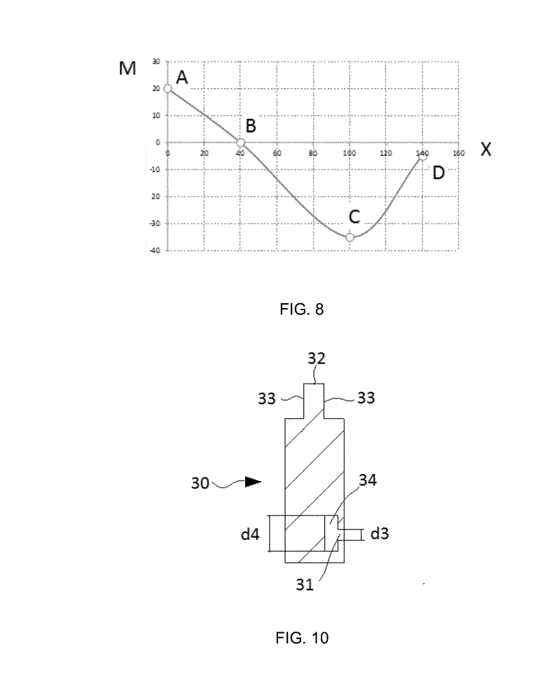

The pedal 1 comprises an assistance device 10 which cooperates in transmitting force to the actuator via the arm 13 such that from a position of the arm 13 with respect to the support 20, called a position with zero force shown in FIG. 5 and depicted by means of point B in a diagram of force/movement shown in FIG. 8, the activation force F′ which must be exerted by the driver on the shoe 14 to further move the arm 13 and operate the actuator is less than the force which would have to be exerted if the pedal 1 did not include the assistance device 10.

The assistance device 10 is arranged articulated to the arm 13 and to the support 20. The assistance device 10 comprises a profile 30 coupled to the arm 13, elastic means 35 coupled to the support 20, rolling means 45,46 adapted for contacting profile 30 and a lever 40 which is arranged pivotally coupled to the support 20 and at one of the ends of which the rolling means 45,46 and the elastic means 35 are coupled. The rolling means 45,46 act on the profile 30 pressed by the lever 40 which is in turn operated by the elastic means 35 exerting additional force on the arm 13 during the stroke of the arm 13 between the resting position and the active position.

The lever 40 comprises two sets of substantially parallel surfaces 41,43 at each end. The lever 40 includes a coupling 42 extending from each surface 41 in a manner substantially orthogonal to the parallel surfaces 41 at one of the ends. The coupling 42 extends outwardly from the lever 40. In the implementations shown in the figures, the coupling 42 has a substantially cylindrical geometry.

The support 20 in turn comprises two substantially parallel walls 24 each of which comprises a housing 22,23 wherein the respective coupling 42 of the lever 40 is housed, configuring a pivoting attachment between the lever 40 and the support 20. The housing 22,23 comprises a first part 23 with a substantially circular section and a second part 22 continuous to the first part 23, communicating the first part 23 with the outside, allowing the insertion of the coupling 42 in the first part 23. The second part 22 has a width less than the diameter of the first part 23, allowing, on one hand, easily inserting the coupling 42 in the first part 23 and on the other hand, preventing the coupling 42 from being easily released from the support 20 once the lever 40 is coupled to the support 20.

According to some implementations the lever 40 comprises, at the opposite end, a projection 44 which is arranged fixed on one of the parallel surfaces 43 arranged at said opposite end and through which the free end of the lever 40 is fixed to the support 20 through the elastic means. In the implementation shown, the projection 44 is substantially disc-shaped.

In some implementation the elastic means comprises a spring 35, one of the ends 36 of which is arranged fixed to the support 20 and the other end 37 to the lever 40. In the implementation shown, the spring 35 is a helical spring, in other implementations other elastic means may be used. In the implementations shown in the figures, the ends 36,37 of the spring 35 are substantially hook-shaped, being inserted in grooves 25b,44b arranged respectively in an extension 25 of the support 20 and in the projection 44 coupled to the lever 40. The grooves 25b,44b extend perimetric to the extension 25 of the support 20 and to the projection 44. The spring 35 is arranged forming an angle with respect to the lever 40, said angle being in some implementations as close as possible to 90°, such that the spring 35 is prevented from generating high radial compression forces in the lever 40, which may cause reactions and therefore friction in the coupling of the end 42 of the lever with the support 20.

According to some implementations the rolling means comprises a wheel 45 which is arranged in contact with a rolling surface 32 of the profile 30 during the movement of the arm 13. The rolling means may comprise at least one stop element 46 which extends continuously from a face of the wheel 45 and which laterally guides the movement of the wheel 45 along the rolling surface 32 together with a guide surface 33 of the profile 30, preventing the accidental decoupling of the wheel 45 with respect to the rolling surface 32. According to some implementations the stop element 46 is disc-shaped and is arranged coaxial to the wheel 45.

In the implementations shown in the figures, the rolling means comprises two stop elements 46 each of which extends continuously from a face of the wheel 45 and coaxial to the wheel 45. Likewise, the profile 30 comprises two guide surfaces 33 each of which extends continuously from the rolling surface 32. The two guide surfaces 33 are arranged substantially parallel to one another and substantially orthogonal to the rolling surface 32, as shown in FIG. 10.

The projection 44 is arranged substantially coaxial to the rolling means. Therefore, the force exerted by the elastic means 35 is successfully transmitted as directly as possible to the rolling surface 32, reducing losses by friction.

FIGS. 4 to 7 show the pedal 1 in different positions each of which corresponds respectively with points A, B, C and D depicted in FIG. 8 showing the reaction force generated by the assistance device 10 on the shoe 14 depending on the movement of the arm 13 of the pedal 1.

Therefore, the pedal 1 first starts from an initial position shown in FIG. 4 in which the spring 35 pulls the lever 40 such that the lever 40 exerts pressure on the wheel 45 against the rolling surface 32 of the profile 30 integral with or otherwise removably coupled to the arm 13 of the pedal 1. From this position, depicted in FIG. 8 by means of point A, and to the position with zero force shown in FIG. 5 and depicted in FIG. 8 by means of point B, the driver must exert a progressive force F on the shoe 14 in order to operate the actuator. During the stroke between both positions, the force F exerted on the shoe 14 must be greater than the case in which the pedal 1 does not include an assistance device 10 because it must overcome the moment generated by the force F1 exerted by the wheel 45 on the profile 30.

In the position with zero force shown in FIG. 5, the assistance device 10 does not exert any reaction on the arm 13 of the pedal 1, the force F′ exerted by the driver on the shoe 14 being similar to the case in which the pedal 1 does not include an assistance device 10 because the force F2 exerted by the wheel 45 on the profile 30 does not generate reaction in the shoe 14.

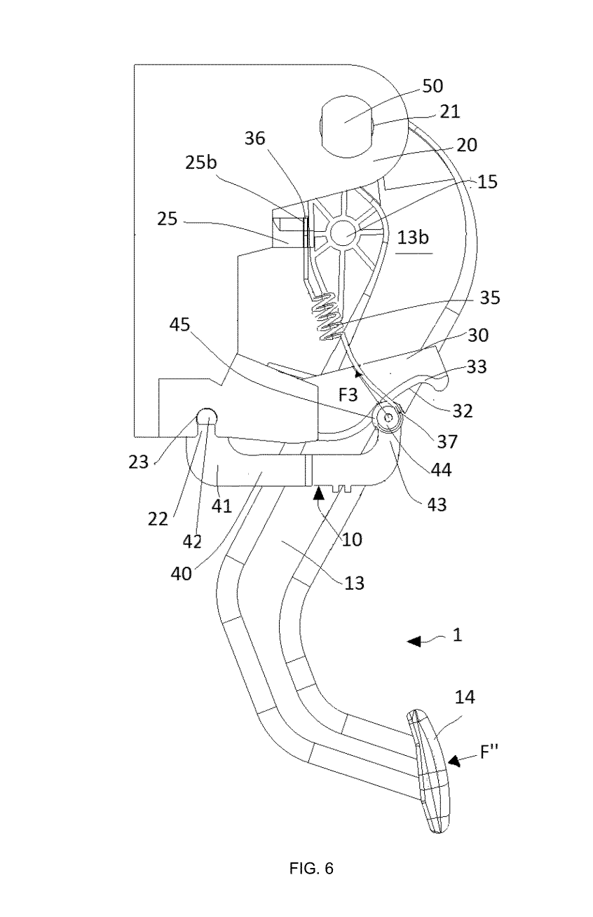

FIG. 6 shows the pedal 1 in a position with maximum reaction force which corresponds with point C of FIG. 8. Therefore, from the position with zero reaction force to the position with maximum reaction force, the driver must exert a force F″ on the shoe 14 in order to operate the actuator, the force F″ being less than the force which must be exerted by the driver in the event that the pedal 1 does not include the assistance device 10 because the force F3 exerted by the wheel 45 on the profile 30 generates a reaction favoring the movement of the shoe 14.

Finally, FIG. 7 shows the pedal 1 in a position with residual reaction force which corresponds with point D of FIG. 8. From the position with maximum reaction force, the driver must exert a force F″′ on the shoe 14 in order to operate the actuator, the force F″′ being gradually greater than the force F″ which must be exerted in the position with maximum reaction force but less than the force which must be exerted in the event that the assistance device 10 is not included because the force F4 exerted by the wheel 45 on the profile 30 generates a reaction favoring the movement of the shoe 14, even though it is less than that in the preceding movement.

The rolling surface 32 of the profile 30 has a curved trajectory suitable for generating forces F1, F2, F3 and F4 for a desired operation of the assistance device 10.

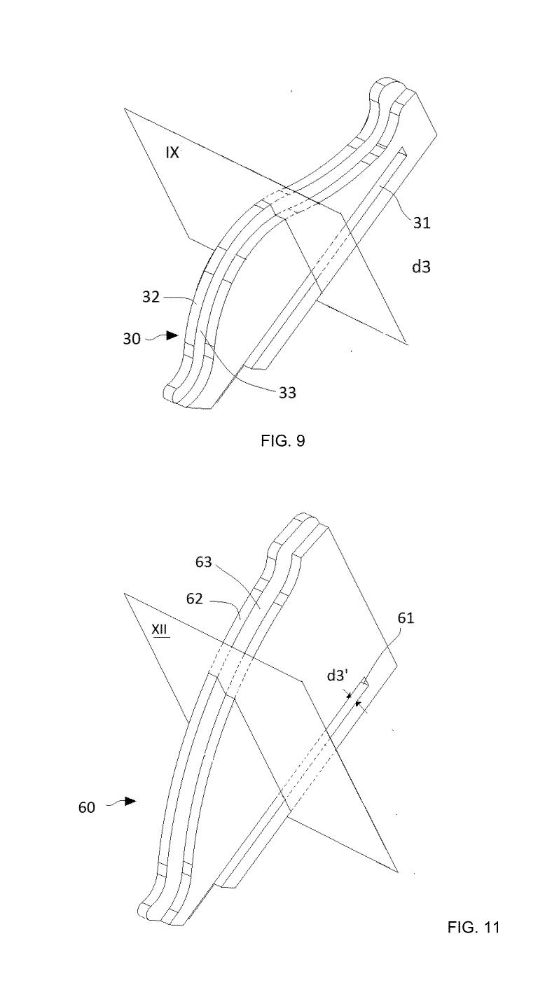

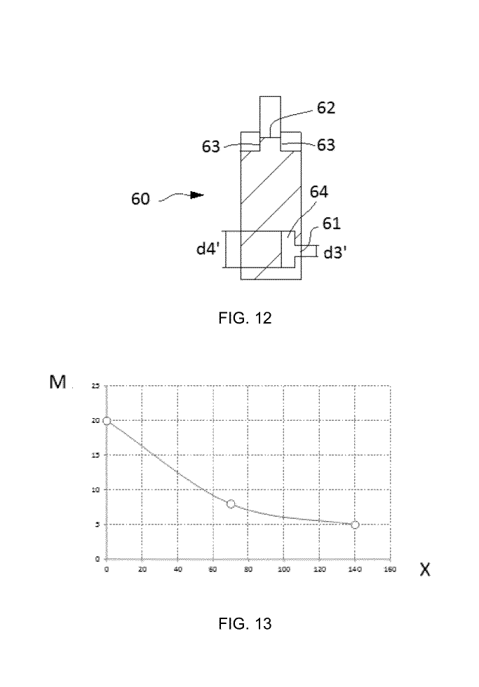

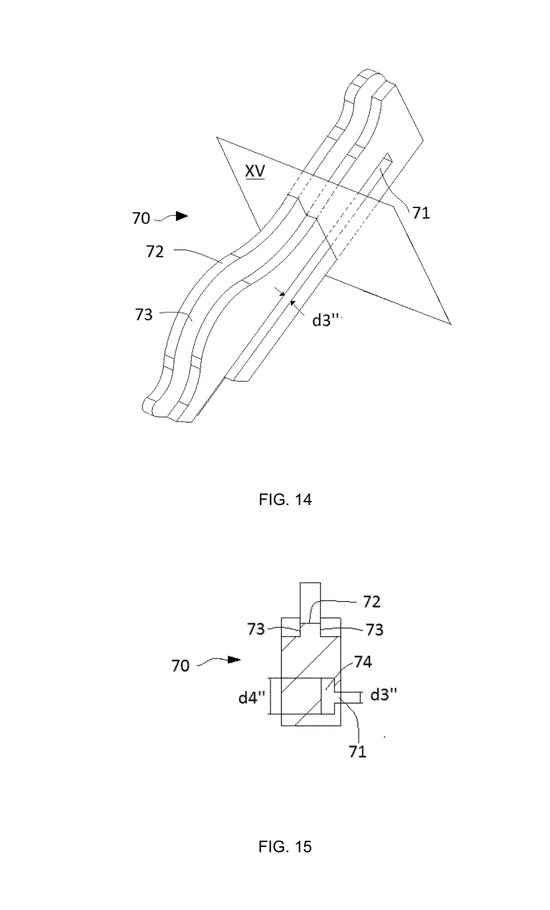

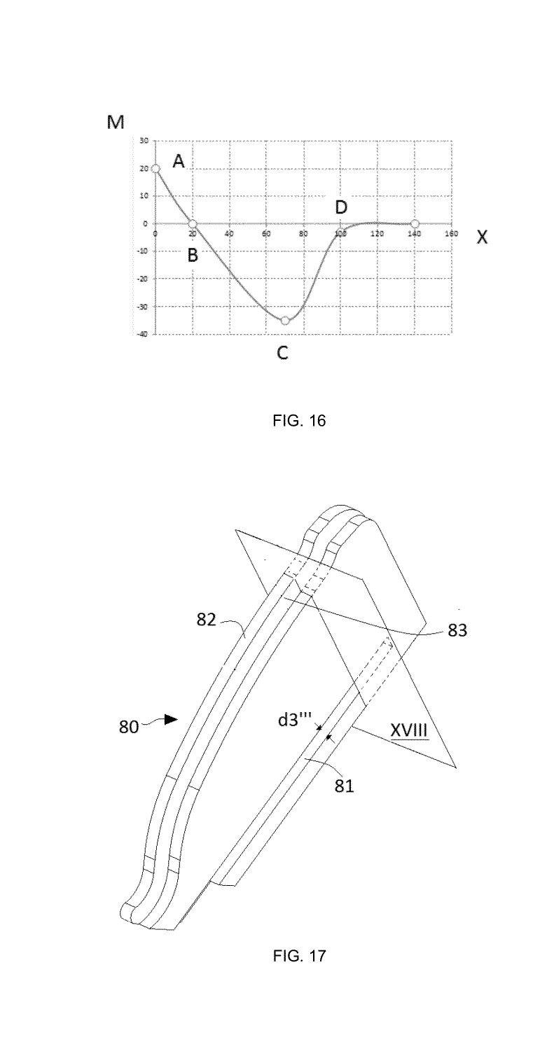

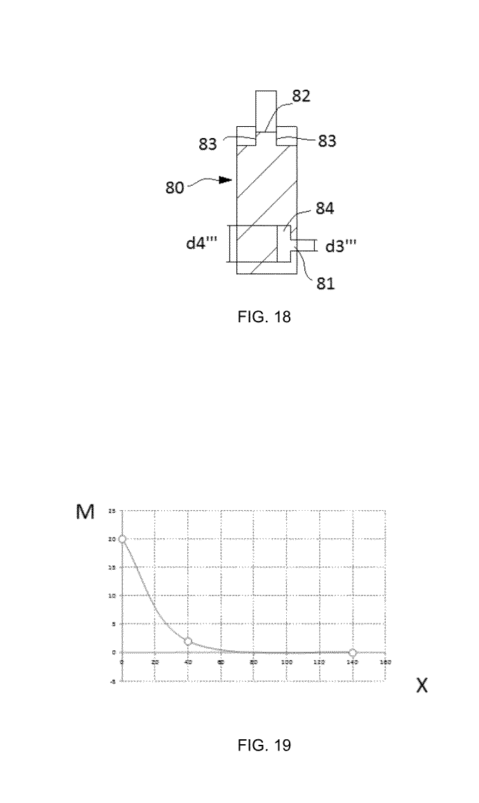

Different profiles 30;60;70;80 such as those shown in FIGS. 8 to 19 with their respective characteristic curves, can be used for different types of vehicles and drives depending on the operation requirements of the pedal 1. Different performances of the pedal 1 adapted to each individual vehicle/drive can thus be obtained by just replacing the profile 30;60;70;80, keeping the rest of the parts common. In the implementation shown in FIGS. 14 to 16, the assistance device 10 acts before the assistance device 10 of FIGS. 4 to 8 so that the maximum reaction force of the assistance device 10 is obtained in a shorter stroke of the arm 13, whereby the driver can tell sooner that he/she must exert less effort on the shoe 14 and in the final sector of the stroke of the arm 13, the assistance device 10 does not act in a manner which can be perceived by the user, which can be beneficial in certain vehicles and drives.

FIGS. 11 to 13 show an implementation of the profile 60 of the assistance device 10 which is characterized in that, throughout the entire stroke of the arm 13, the force exerted by the driver on the shoe 14 is greater than that which would be necessary if the pedal 1 did not include an assistance device 10. The assistance device 10 comprising the profile 60 causes said arm 13 to tend to return to the resting position throughout the entire stroke of the arm 13.

FIGS. 17 to 19 show another implementation of the profile 80 of the assistance device 10 in which the force exerted by the driver on the shoe 14 is greater than that which would be necessary if the pedal 1 did not include an assistance device 10 only throughout a first sector of the stroke of the arm 13, whereas subsequently, the assistance device 10 does not act in a manner which can be perceived by the user.

In order to obtain an optimized, readily interchangeable pedal 1, the pedal 1 can be adapted to any requirement for use by modifying the profile. To that end, the pedal 1 may comprise a profile 30;60;70;80 which is arranged removable to the arm 13 of the pedal 1, said profile 30;60;70;80 being readily interchangeable. To that end, the profile 30;60;70;80 may comprise a housing 34;64;74;84 collaborating with a projection 12 protruding from the arm 13 of the pedal 1 for fixing the profile 30;60;70;80 to the arm 13. The projection 12 shown in FIG. 3 has a substantially T-shaped cross-section. The projection 12 may comprise a first substantially rectangular part 12a, defined by width d1, extending continuously to the arm 13 and a second part 12b with a substantially rectangular section defined by width d2 and continuous to the first part 12a. The width d1 of the first part 12a is less than the width d2 of the second part 12b. The housing 34;64;74;84 of the profile 30;60;70;80 extends longitudinally along the profile 30;60;70;80, communicating with the outside through a groove 31;61;71;81 having a width d3;d3′;d3″;d3″′, shown in FIGS. 9, 12, 15 and 18, greater than the width dl of the first part 12a of the projection 12. The housing 34;64;74;84 has a substantially rectangular section defined by width d4;d4′;d4″;d4″′ such that the second part 12b of the projection 12 is tightly housed in the respective housing 34;64;74;84.

Elements 62;72;82 correspond in a like manner to element 32 described above. Elements 63;73;83 correspond in a like manner to element 33 described above.

What is claimed is:

1. A pedal assembly for a motor vehicle comprising:
a support attached to the motor vehicle,
an arm having at a first end a surface adapted for receiving a first force applied by an operator of the motor vehicle, the arm having a second end opposite the first end that is pivotly coupled to the support at a first vertical location, the arm pivotal between a rest position and one or more active positions,
a profile attached in a fixed angular relationship to the arm at a location between the first and second ends of the arm, the profile having an elongate curved surface,
a lever having a first end pivotly coupled to the support at a second vertical location that is below the first vertical location, the lever having a second end with an element that is adapted to move along the elongate curved surface of the profile when the arm is moved between the rest position and the one or more active positions,
a resilient member having a first end and a second end, the first end coupled to the support between the first and second vertical locations, the second end coupled to the second end of the lever at or near the location of the element,
the arm, profile, lever and resilient member arranged so that when the arm is in one of the active positions the resilient member applies a force to the second end of the lever to cause the element to act upon at least a portion of the elongate curved surface of the profile in a manner that causes the profile to apply a force component on the arm that extends in a direction of the first force.

2. A pedal assembly according to claim 1, wherein the resilient member is a helical spring.

3. A pedal assembly according to claim 1, wherein the element at the second end of the lever is a rolling element rotationally coupled to the second end, the rolling element adapted to roll along the elongate curved surface of the profile when the arm is moved between the rest position and the one or more active positions.

4. A pedal assembly according to claim 3, further comprising a stop element arranged on a side of the rolling element to guide the movement of the rolling element along the elongate curved surface of the profile.

5. A pedal assembly according to claim 3, further comprising first and second stop elements arranged on respective first and second sides of the rolling element to guide the movement of the rolling element along the elongate curved surface of the profile.

6. A pedal assembly according to claim 1, wherein the profile is removably coupled to the arm.

7. A pedal assembly according to claim 6, further comprising a projection protruding from the arm for fixing the profile to the arm, the profile comprising a housing wherein resides at least a portion of the projection.

8. A pedal assembly for a motor vehicle comprising:
a support attached to the motor vehicle,
an arm having at a first end a surface adapted for receiving a first force applied by an operator of the motor vehicle, the arm having a second end opposite the first end that is pivotly coupled to the support at a first vertical location, the arm pivotal between a rest position and one or more active positions,
a profile attached in a fixed angular relationship to the arm at a location between the first and second ends of the arm, the profile having an elongate curved surface,
a lever having a first end pivotly coupled to the support at a second vertical location that is below the first vertical location, the lever having a second end with an element that is adapted to move along the elongate curved surface of the profile when the arm is moved between the rest position and the one or more active positions,
a resilient member having a first end and a second end, the first end coupled to the support between the first and second vertical locations, the second end coupled to the second end of the lever at or near the location of the element,
the arm, profile, lever and resilient member arranged so that when the arm is in one of the active positions the resilient member applies a force to the second end of the lever to cause the element to act upon at least a portion of the elongate curved surface of the profile in a manner that causes the profile to apply a force component on the arm that extends in a direction opposite to the first force.

9. A pedal assembly according to claim 8, wherein the resilient member is a helical spring.

10. A pedal assembly according to claim 8, wherein the element at the second end of the lever is a rolling element rotationally coupled to the second end, the rolling element adapted to roll along the elongate curved surface of the profile when the arm is moved between the rest position and the one or more active positions.

11. A pedal assembly according to claim 10, further comprising a stop element arranged on a side of the rolling element to guide the movement of the rolling element along the elongate curved surface of the profile.

12. A pedal assembly according to claim 10, further comprising first and second stop elements arranged on respective first and second sides of the rolling element to guide the movement of the rolling element along the elongate curved surface of the profile.

13. A pedal assembly according to claim 8, wherein the profile is removably coupled to the arm.

14. A pedal assembly according to claim 13, further comprising a projection protruding from the arm for fixing the profile to the arm, the profile comprising a housing wherein resides at least a portion of the projection.

15. A pedal assembly for a motor vehicle comprising:
a support attached to the motor vehicle,
an arm having at a first end a surface adapted for receiving a first force applied by an operator of the motor vehicle, the arm having a second end opposite the first end that is pivotly coupled to the support at a first vertical location, the arm pivotal between a rest position and one or more active positions,
a profile attached in a fixed angular relationship to the arm at a location between the first and second ends of the arm, the profile having an elongate curved surface, the elongate curved surface having a first section and a second section,
a lever having a first end pivotly coupled to the support at a second vertical location that is below the first vertical location, the lever having a second end with an element that is adapted to move along the elongate curved surface of the profile when the arm is moved between the rest position and the one or more active positions,
a resilient member having a first end and a second end, the first end coupled to the support between the first and second vertical locations, the second end coupled to the second end of the lever at or near the location of the element,
the arm, profile, lever and resilient member arranged so that when the arm is in one of the active positions the resilient member applies a force to the second end of the lever to cause the element to act upon the elongate curved surface of the profile, wherein when the element acts upon the first section of the elongate curved surface of the profile it causes the profile to apply a force component on the arm that extends in a direction of the first force and when the element acts upon the second section of the elongate curved surface of the profile it causes the profile to apply a force component on the arm that extends in a direction opposite the first force.

16. A pedal assembly according to claim 15, wherein the resilient member is a helical spring.

17. A pedal assembly according to claim 15, wherein the element at the second end of the lever is a rolling element rotationally coupled to the second end, the rolling element adapted to roll along the elongate curved surface of the profile when the arm is moved between the rest position and the one or more active positions.

18. A pedal assembly according to claim 17, further comprising a stop element arranged on a side of the rolling element to guide the movement of the rolling element along the elongate curved surface of the profile.

19. A pedal assembly according to claim 17, further comprising first and second stop elements arranged on respective first and second sides of the rolling element to guide the movement of the rolling element along the elongate curved surface of the profile.

20. A pedal assembly according to claim 15, wherein the profile is removably coupled to the arm.

21. A pedal assembly according to claim 20, further comprising a projection protruding from the arm for fixing the profile to the arm, the profile comprising a housing wherein resides at least a portion of the projection.
